(19) United States
(12) Patent Application Publication
(10) Pub. No.: US 2005/0286007 A1
(43) Pub. Date: Dec. 29, 2005

(54) Liquid crystal display device

(75) Inventor: Joung Won Woo, Suwon-shi (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/157,765

(22) Filed: Jun. 21, 2005

(30) Foreign Application Priority Data
Jun. 28, 2004 (KR) P 2004-49022

(51) Int. Cl. G02F 1/1339

(52) U.S. Cl. 349/155

(57) ABSTRACT

An LCD capable of preventing a gravity failure is provided. The LCD makes substrates constituting an LC panel not easily warped. The LCD includes a first substrate and a second substrate facing each other, a liquid crystal layer interposed between the first substrate and the second substrate, and a gravity failure-prevention structure, for preventing at least one of the first and second substrates from warping, formed on the at least one of the first substrate and the second substrate.

This application claims the benefit of Korean Application No. P 2004-49022 filed on Jun. 28, 2004, which is hereby incorporated by reference.

### FIELD OF THE INVENTION

The present invention relates to a liquid crystal display device, and more particularly, to a liquid crystal display capable of improving gravity failure.

### DISCUSSION OF THE RELATED ART

Among ultra-slim flat panel displays having a display screen whose thickness is merely several centimeters, a liquid crystal display device (LCD) has the advantage of a low operation voltage, resulting in low power consumption, and portability. Accordingly, the LCD can be widely used in a variety of applications, such as notebook computers, monitors, spacecraft and aircraft instrumentation.

A related LCD will be described in detail with reference to the accompanying drawings.

FIG. 1 is an exploded perspective view of a related art LCD and FIG. 2 is a schematic sectional view of a related art LCD.

Referring to FIG. 1, the LCD includes a lower substrate 10 and an upper substrate 20 facing each other and spaced a predetermined interval apart from each other, and a liquid crystal layer (not shown) interposed between the two substrates.

The lower substrate 10 has gate lines 12 and data lines 14 intersecting horizontally and vertically each other to define pixel regions. Further, thin film transistors (TFTs) ‘T’ serving as switching elements are formed at intersection regions of the gate lines and the data lines 12 and 14. Pixel electrodes 16 connected with the TFTs are formed on the pixel regions.

A black matrix (BM) layer 22 for preventing light from leaking out through regions other than the pixel regions is formed on the upper substrate 20. A color filter layer 24 including red, green, and blue color filters for expressing colors is formed on regions of the upper substrate that correspond to the pixel regions. A common electrode 26 is formed on the color filter layer 24.

Further, referring to FIG. 2, a spacer 30 is provided between the lower and upper substrates 10 and 20 so that a gap cell of the LCD may be maintained constant.

The spacer includes a ball spacer formed by mixing spherical spacers with a solution at a proper density and dispersing the spherical spacers on the substrate, and a column spacer formed by attaching a pillar-shaped spacer on the substrate. Since the ball spacer has a disadvantage that a cell gap is not uniform as applied on a large area, the column spacer is mainly used for a large-sized substrate.

Also, a sealant 40 is formed at an outer periphery between the lower and upper substrates 10 and 20 such that the two substrates may be attached to each other.

The above-described LCD is manufactured by a process, which includes: preparing a lower substrate by forming gate lines, data lines, TFTs, and pixel electrodes on the lower substrate; preparing an upper electrode by forming a BM layer, a color filter layer, and a common electrode on the upper electrode; forming a liquid crystal layer between the two prepared substrates, and attaching the two substrates together.

At this point, to attach the two substrates together and form the liquid crystal layer between the two substrates after the two substrates are attached, two methods, i.e., a liquid crystal injection method and a liquid crystal dropping method are generally used.

In the liquid crystal injection method, a sealant having an injection hole is formed on either of the two prepared substrates, the two substrates are attached together, and liquid crystal is injected between the two substrates through the injection hole.

In the liquid crystal dropping method, a sealant having no injection hole is formed on either of the two prepared substrates, liquid crystal is dropped on the selected one substrate, and the two substrates are attached together.

When the substrate increases in size and the liquid crystal is injected by the liquid crystal injection method, a liquid crystal injection time increases, so that productivity is deteriorated. Therefore, in case of a large-sized substrate, the liquid crystal dropping method is generally used.

In the liquid crystal dropping method, the proper quantity of liquid crystal is computed prior to providing the liquid crystal. That is, the liquid crystal dropping method drops liquid crystal by an amount computed in advance on either of the two substrates, unlike the liquid crystal injection method. Accordingly, if the computed amount of liquid crystal is too small, a space without liquid crystal is generated in an inside of a liquid crystal panel. If the computed amount of liquid crystal is too large, the liquid crystal overflows from the inside of the liquid crystal panel, which deteriorates the display quality.

Therefore, the amount of the liquid crystal should be computed appropriately with consideration of the size and height of the cell. However, it is not easy to accurately compute the amount of the liquid crystal. Therefore, the amount of the liquid crystal is generally computed so that the amount of the liquid crystal may not be deficient. In preparation for when the amount of liquid crystal is excessive, a variety of methods for accommodating the excessive liquid crystal in regions other than active regions where an image is not actually displayed on the screen, are being researched.

Since the LCDs are mainly applied to monitors, TVs and the like, they are generally used in an upright position. Therefore, if the amount of liquid crystal is excessive, the liquid crystal moves to a lower side, so that the lower portion of the liquid crystal panel gets swollen (called gravity failure) Particularly, if a temperature of the liquid crystal panel rises, the liquid crystal expands, so that the “gravity failure” phenomenon gets severe.

FIG. 3 is a view illustrating a gravity failure of the related art LCD. As described above, when the LCDs are employed as the monitors, the TVs and the like, they are used upright and the amount of the dropped liquid crystal is not deficient. Therefore, as seen from FIG. 3, as the liquid crystal filled by the liquid crystal dropping method moves in a gravity direction (an arrow direction), both the substrates 10 and 20 are warped outward as the liquid crystal travels the lower portion, so that a cell gap in the lower portion gets wider than a cell gap in the upper portion, which deteriorates the image display quality.

### SUMMARY OF THE INVENTION

By way of introduction only, an LCD capable of preventing a gravity failure by making substrates constituting a liquid crystal panel not easily warped while the liquid crystal moves to the lower portion.

In one aspect, an LCD includes: a first substrate and a second substrate facing each other; a liquid crystal layer interposed between the first substrate and the second substrate; and a gravity failure prevention structure, for preventing at least one of the first and second substrates from warping, formed on the at least one of the first and second substrates.

In various embodiments, the gravity failure prevention structure is formed on both the first substrate and the second substrate. Alternatively, the gravity failure prevention structure may be formed on region where light is not transmitted other than pixel regions. In other words, if the gravity failure prevention structure is formed on a lower substrate, the gravity failure prevention structure may be formed on the gate lines and/or the data lines. If the gravity failure prevention structure is formed on an upper substrate, the gravity failure prevention structure may be formed on the black matrix layer. The gravity failure prevention structure may be shaped in a plurality of bars or in a net. The gravity failure prevention structure may have a vertical section shaped in a triangle, a semicircle, a trapezoid, or a rectangle.

According to the present invention, the gravity failure prevention structure is formed on one or both of the substrates constituting the LCD. Accordingly, even if the liquid crystal panel stands upright and the liquid crystal moves to the lower portion, the substrate is not warped, thereby preventing the lower portion of the liquid crystal panel from being swollen.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of a related art LCD;

FIG. 2 is a schematic sectional view of a related art LCD;

FIG. 3 is a view illustrating a gravity failure of a related art LCD;

FIG. 4 is a schematic plan view of a lower substrate of an LCD according to one embodiment of the present invention;

FIG. 5 is a sectional view taken along line I-I′ of FIG. 4;

FIG. 6 is a sectional view of a gravity failure prevention structure according to one embodiment of the present invention;

FIG. 7 is a schematic plan view of an upper substrate of an LCD according to one embodiment of the present invention; and

FIG. 8 is a sectional view taken along line II-II′ of FIG. 7.

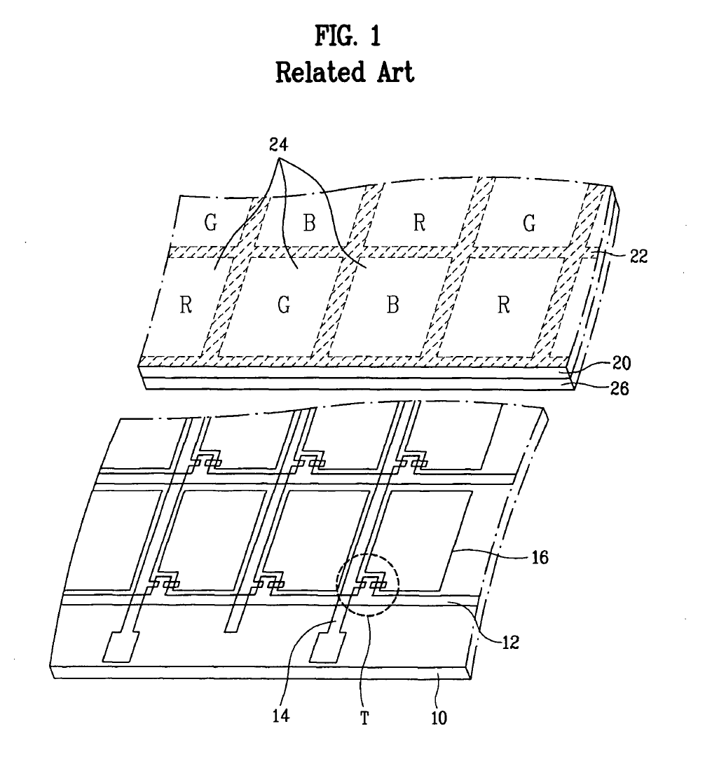

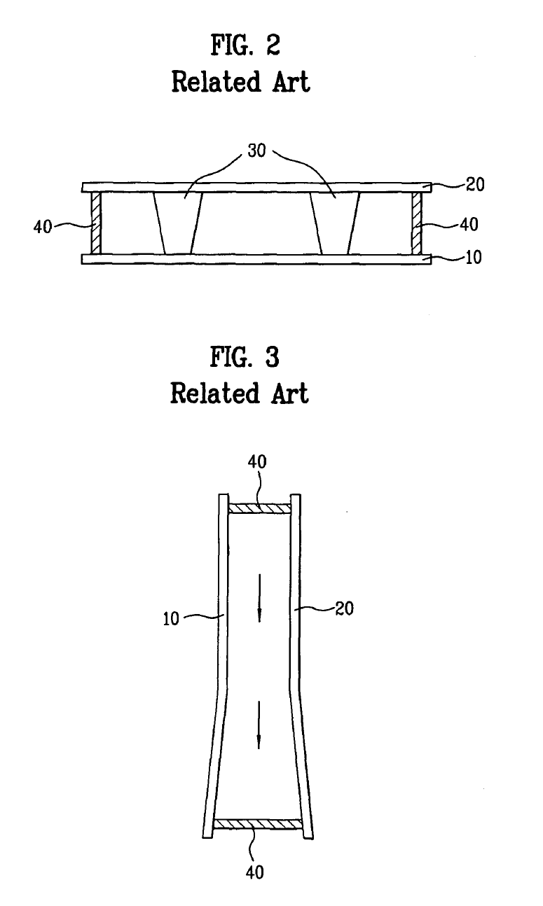

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

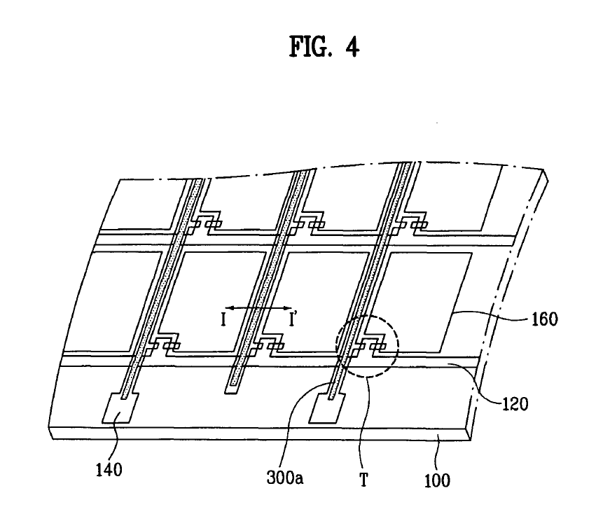

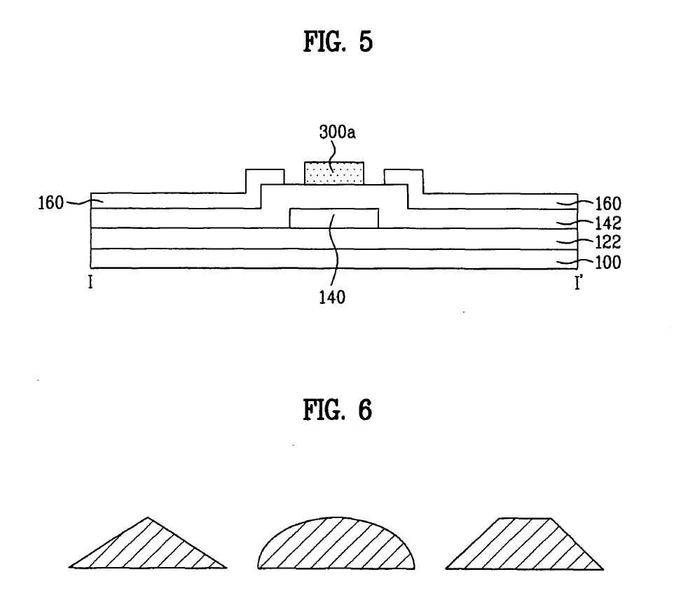

FIG. 4 is a schematic, plan view of a lower substrate of an LCD according to one embodiment of the present invention, and FIG. 5 is a cross-sectional view taken along line I-I′ of FIG. 4.

Referring to FIGS. 4 and 5, the LCD, according to one embodiment of the present invention, includes gate lines 120 and data lines 140 for defining pixel regions on a lower substrate 100 by intersecting horizontally and vertically.

Further, TFTs, as switching elements, are formed on regions of intersection of the gate lines 120 and the data lines 140. Each of the TFTs is formed by sequentially stacking a gate electrode, a gate insulation layer (see reference numeral 122 in FIG. 5), a semiconductor layer, and source and drain electrodes.

Further, a passivation layer (see reference numeral 142 in FIG. 5) is formed on an entire surface of a substrate including the TFTs ‘T’. A contact hole is formed in the passivation layer at an upper portion of the drain electrode of the TFT. A pixel electrode 160 is formed on the passivation layer that corresponds to each pixel region, and the pixel electrode 160 is connected with the drain electrode of the TFT through the contact hole.

In addition, a gravity-failure-prevention structure 300a for preventing a gravity failure is formed on the passivation layer 142 in the shape of a plurality of bars located on the upper portion of the data lines 140. Although the gravity-failure-prevention structure 300a is formed on the upper portion of all the data lines 140, according to the drawing, a single structure can be formed for every two or more data lines.

Furthermore, while the gravity-failure-prevention structure 300a is formed in the shape of bars on the upper portion of the data lines 140, the gravity-failure-prevention structure 300a can be also formed in the shape of bars on the upper portion of the gate lines 120. Further, the gravity-failure-prevention structure can be formed in the shape of a net on the upper portion of the gate lines 120 and the data lines 140. The gravity failure-prevention structure can be formed along at least one of a set of gate lines or a set of data lines. The set of gate lines or data lines may be every other gate or data line. In each case, the gravity-failure-prevention structure 300a may be smaller in width than the width of the data lines 140, the width of the gate lines 120, or thereboth.

Referring to FIG. 6, the gravity-failure-prevention structure 300a can be rectangular, triangular, semicircular, or trapezoidal in its vertical cross-section.

Since the gravity-failure-prevention structure 300a prevents the lower substrate 100 from warping, any material can be used if it has an appropriate rigidity. For the gravity-failure-prevention structure 300a, photoacryl is preferably used.

Though not shown, an alignment film can be formed on an entire surface of the substrate that includes the gravity-failure-prevention structure 300a.

The alignment film can be formed by performing a rubbing process using material such as polyamide or polyimide-based compound, polyvinylalcohol (PVA), and polyamic acid. Further, the alignment film can be formed by performing an optical alignment process using optically reactive material such as polyvinylcinnamate (PVCN), polysiloxanecinnamate (PSCN), and cellulosecinnamate (CelCN) compounds. The optical alignment process simultaneously determines a pretilt angle and an alignment direction by at least once light illumination. The light illumination may be performed using light in the ultraviolet region. Non-polarized light, linearly polarized light, or partially polarized light can be used.

Referring to FIGS. 4 and 5, although the gravity-failure-prevention structure 300a formed on the lower substrate 100 is shown formed on the side facing the liquid crystal layer, it can also be formed on the opposite side of the lower substrate 100.

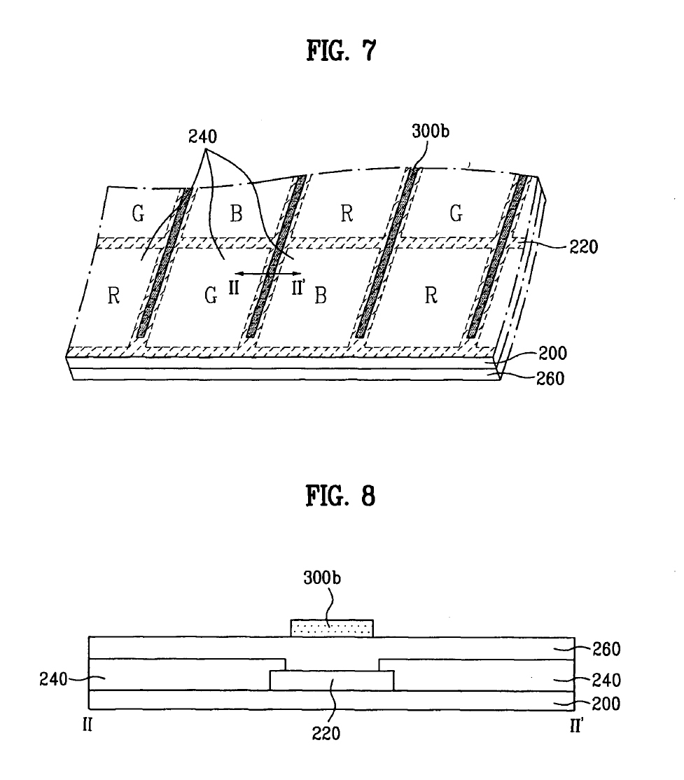

FIG. 7 is a schematic plan view of the upper substrate of an LCD according to one embodiment of the present invention, and FIG. 8 is a sectional view taken along line II-II′ of FIG. 7.

Referring to FIGS. 7 and 8, a black matrix layer 220 for preventing light leakage from the non-pixel regions and a color filter layer 240 for realizing pixel region colors are formed on the upper substrate 200. Further, common electrodes 260 are formed on a surface of the color filter layer 240.

Though not shown, an overcoat layer for performing the substrate planarization and protecting the color filter layer 240 may be additionally formed between the color filter layer 240 and the common electrodes 260.

Further, a gravity failure-prevention structure 300b is formed in as a plurality of bars on the common electrodes 260 on a surface of the BM layer 220.

Though the gravity-failure-prevention structure 300b is shown formed as bars disposed in a vertical direction on the surface of the BM layer 220 in the drawing, the gravity-failure-prevention structure 300b may also be formed as bars disposed in a horizontal direction, or in the form of a net whose netted lines are disposed horizontally and a vertically. Furthermore, the gravity failure-prevention structure can be formed along every line forming the black matrix or along a set of lines forming the black matrix such as every other line.

The width of the gravity-failure-prevention structure 300b may be smaller than that of the BM layer 220. For the material thereof, photoacryl may be used as described above.

Further, as described above, the gravity-failure-prevention structure 300b may be rectangular, triangular, semicircular, or trapezoidal in its vertical section.

Though not shown, a column spacer may be additionally formed on a surface of the common electrodes 260.

Though not shown, an alignment film may be formed on a front surface of the substrate that includes the gravity-failure-prevention structure 300b. The material of the alignment film and the method for forming the alignment film are the same as those in the embodiment described with reference to FIGS. 4 and 5.

In the meantime, referring to FIGS. 7 and 8, although the gravity-failure-prevention structure formed on the upper substrate is formed on the side facing the liquid crystal layer, it can also be formed on the opposite side of the upper substrate.

In the above, description has been made for the lower substrate and the upper substrate constituting the LCD of the present invention. The LCD includes the lower and upper substrates 100 and 200 on which the gravity-failure-prevention structures 300a and 300b are formed and the liquid crystal layer formed between both the two substrates. However, the gravity-failure-prevention structure can be formed on only one of the two substrates.

In an in-plane switching (IPS) mode LCD, a common electrode is formed on a lower substrate, pixel electrodes are formed in parallel with the common electrode but with a predetermined distance therebetween, and the alignment of a liquid crystal layer is adjusted by an electric field between the common electrode and the pixel electrodes.

Therefore, if the present invention is applied to the IPS mode LCD, the common electrodes 260 that are formed on the upper substrate 200 are formed on the lower substrate 100. Other elements can be properly modified within the scope of the present invention. The IPS mode LCD may have an overcoat layer for protecting the color filter layer. Therefore, the gravity-failure-prevention structure may be formed on the overcoat layer on the surface of the BM layer.

According to the LCD of the present invention, the gravity-failure-prevention structure is formed on the upper substrate and/or the lower substrate, so that the substrate is not warped, even if the liquid crystal moves toward the lower portion (in the case where the liquid crystal panel stands upright). Therefore, the so-called gravity failure phenomenon, where the lower portion of the liquid crystal panel is swollen, can be effectively prevented.

It will be apparent to those skilled in the art that various modifications and variations can be made in the present invention. Thus, it is intended that the present invention covers the modifications and variations of this invention provided they come within the scope of the appended claims and their equivalents.

1. A liquid crystal display device, comprising:
a first substrate and a second substrate facing each other;
a liquid crystal layer interposed between the first substrate and the second substrate; and
a gravity failure-prevention structure, for preventing at least one of the first and second substrates from warping, formed on the at least one of the first and second substrates.

2. The liquid crystal display device of claim 1, wherein the first substrate comprises:
gate lines and data lines intersecting each other to define pixel regions;
TFTs formed on regions where the gate lines and the data lines intersect; and
pixel electrodes connected with drain electrodes of the TFTs and formed on the pixel regions.

3. The liquid crystal display device of claim 2, wherein the first substrate further comprises common electrodes formed on the pixel regions and spaced a predetermined distance apart from the pixel electrodes.

4. The liquid crystal display device of claim 2, wherein the gravity failure-prevention structure is formed on at least one of the gate lines or the data lines.

5. The liquid crystal display device of claim 4, wherein the gravity failure-prevention structure has a width that is narrower than that of the data line or the gate line

6. The liquid crystal display device of claim 1, wherein the second substrate comprises:
a black matrix layer formed on regions other than pixel regions; and
a color filter layer formed on the pixel regions.

7. The liquid crystal display device of claim 6, wherein the second substrate further comprises common electrodes formed on an entire surface of the substrate including the black matrix layer and the color filter layer.

8. The liquid crystal display device of claim 6, wherein the gravity failure-prevention structure is formed on the black matrix layer.

9. The liquid crystal display device of claim 1, wherein the gravity failure-prevention structure comprises a plurality of bars.

10. The liquid crystal display device of claim 1, wherein the gravity failure-prevention structure has a shape of a net.

11. The liquid crystal display device of claim 1, wherein the gravity failure-prevention structure has a vertical section shaped in at least one of a triangle, a semicircle, a trapezoid, or a rectangle.

12. The liquid crystal display device of claim 1, wherein the gravity failure-prevention structure is formed on a surface of each of the first and second substrates.

13. The liquid crystal display device of claim 1, wherein the gravity failure-prevention structure comprises photoacryl.

14. A method for fabricating a liquid crystal display device, the method comprising:
forming a gate line and a data line crossing each other to define a pixel region on a substrate;
forming a thin film transistor at a crossing portion of the gate line and the data line;
forming a passivation layer on an entire surface of the substrate including the gate and data lines; and
forming a gravity failure-prevention structure on the passivation layer over at least one of the gate line or the data line.

15. The method of claim 14, wherein the gravity failure-prevention structure has a width that is narrower than that of the at least one of the data line or the gate line.

16. The method of claim 14, wherein the gravity failure-prevention structure has a vertical section shaped in at least one of a triangle, a semicircle, a trapezoid, or a rectangle.

17. The method of claim 14, wherein the gravity failure-prevention structure comprises photoacryl.

18. A method for fabricating a liquid crystal display device, the method comprising:
forming a black matrix layer on regions other than pixel regions of a substrate;
forming a color filter layer on the pixel regions of the substrate; and
forming a gravity failure-prevention structure on the black matrix layer.

19. The method of claim 18, further comprising forming a common electrode on an entire surface of the substrate including the black matrix layer and the gravity failure-prevention structure.

20. The method of claim 18, wherein the gravity failure-prevention structure has a vertical section shaped in at least one of a triangle, a semicircle, a trapezoid, or a rectangle.

21. The method of claim 18, wherein the gravity failure-prevention structure comprises photoacryl.

22. A liquid crystal display device, comprising:
a first and second substrate facing each other, at least one of the first and second substrates containing a plurality of opaque lines formed thereon, the opaque lines including at least one of signal lines and a black matrix, the signal lines including gate and data lines;
a liquid crystal layer interposed between the first substrate and the second substrate; and
a gravity failure-prevention structure formed along the plurality of the opaque lines.

23. The liquid crystal display device of claim 22, wherein the gravity failure-prevention structure is formed along both the gate lines and the data lines.

24. The liquid crystal display device of claim 22, wherein the gravity failure-prevention structure is formed along both the signal lines and the black matrix.

25. The liquid crystal display device of claim 22, wherein the signal lines and the black matrix are formed on different substrates.

26. The liquid crystal display device of claim 25, further comprising a passivation layer formed on the signal lines, the gravity failure-prevention structure formed on passivation layer.

27. The liquid crystal display device of claim 26, wherein the gravity failure-prevention structure is formed along both the gate lines and the data lines.

28. The liquid crystal display device of claim 22, wherein the gravity failure-prevention structure is formed along at least one of every gate line or every data line.

29. The liquid crystal display device of claim 22, wherein the gravity failure-prevention structure is formed along every line forming the black matrix.

30. The liquid crystal display device of claim 22, wherein the gravity failure-prevention structure is formed along at least one of a set of gate lines or a set of data lines.

31. The liquid crystal display device of claim 30, wherein the at least one of the set of gate lines or the set of data lines is at least one of every other gate line or every other data line.

32. The liquid crystal display device of claim 22, wherein the gravity failure-prevention structure is formed along a set of lines forming the black matrix.

33. The liquid crystal display device of claim 32, wherein the set of lines is every other line.

34. The liquid crystal display device of claim 22, wherein a width of the gravity failure-prevention structure is smaller than a width of the opaque lines along which the gravity failure-prevention structure is formed.

35. The liquid crystal display device of claim 22, wherein a vertical cross-section of the gravity failure-prevention structure is at least one of rectangular, triangular, semicircular, or trapezoidal.
